(19) United States
(12) Patent Application Publication
(10) Pub. No.: US 2026/0301767 A1
(43) Pub. Date: Oct. 1, 2026

(54) MAGNETIC RECORDING AND REPRODUCING APPARATUS

(71) Applicant: Resonac Hard Disk Corporation, Chiba (JP)

(72) Inventors: Noriyuki ASAKURA, Chiba (JP); Fumito KUDO, Chiba (JP)

(21) Appl. No.: 19/555,160

(22) Filed: Mar. 3, 2026

(30) Foreign Application Priority Data
Mar. 31, 2025 (JP) 2025-058444

(51) Int. Cl. G11B 5/66; G11B 5/00; G11B 5/667

(52) U.S. Cl. CPC G11B 5/672; G11B 5/667; G11B 5/676; G11B 2005/0024

(57) ABSTRACT

A magnetic recording and reproducing apparatus includes a magnetic recording medium including a plurality of magnetic recording layers disposed on a nonmagnetic substrate; and a magnetic recording and reproducing head including a high-frequency magnetic field generating element. The magnetic recording and reproducing head includes a recording pole configured to generate a recording magnetic field for writing information onto the magnetic recording medium. The recording pole has a width within a range between 30 nm and 80 nm in a radial direction of the magnetic recording medium. The high-frequency magnetic field generating element has a width smaller than that of the recording pole. One of the plurality of magnetic recording layers that is closest to the high-frequency magnetic field generating element is a magnetic layer having a granular structure containing isolated magnetic grains including Co and Pt and having an hcp structure with c-axis orientation.

### CROSS-REFERENCE TO RELATED APPLICATIONS

This application claims priority to Japanese Patent Application No. 2025-058444, filed Mar. 31, 2025, the entire content of which is incorporated herein by reference.

### BACKGROUND

### 1. Technical Field

The present disclosure relates to a magnetic recording and reproducing apparatus.

### 2. Description of Related Art

In recent years, microwave-assisted magnetic recording (MAMR), a method in which a magnetic recording medium is irradiated with microwaves during recording, has attracted considerable attention as a next-generation recording technology capable of achieving an areal recording density of approximately 2 Tbit/in².

In microwave-assisted magnetic recording, information can be written onto a magnetic layer with a high coercive force using a relatively low magnetic field by exploiting the reduction in effective coercivity that occurs when magnetic grains absorb energy from a high-frequency magnetic field.

For example, Japanese Unexamined Patent Application Publication No. 2013-229084 (hereinafter “Patent Document 1”) and Japanese Unexamined Patent Application Publication No. 2015-49926 (hereinafter “Patent Document 2”) describe a microwave-assisted magnetic recording and reproducing apparatus capable of achieving a high recording density.

### SUMMARY

According to the present disclosure, a magnetic recording and reproducing apparatus includes a magnetic recording medium including a plurality of magnetic recording layers disposed on a nonmagnetic substrate; and a magnetic recording and reproducing head including a high-frequency magnetic field generating element. The magnetic recording and reproducing head includes a recording pole configured to generate a recording magnetic field for writing information onto the magnetic recording medium. The recording pole has a width within a range between 30 nanometers (nm) and 80 nm in a radial direction of the magnetic recording medium. The high-frequency magnetic field generating element has a width smaller than that of the recording pole. One of the plurality of magnetic recording layers that is closest to the high-frequency magnetic field generating element is a magnetic layer having a granular structure containing isolated magnetic grains including Co and Pt and having an hcp structure with c-axis orientation.

### BRIEF DESCRIPTION OF THE DRAWINGS

FIG. 1 is a perspective view schematically illustrating a magnetic recording and reproducing apparatus according to an embodiment of the present disclosure;

FIG. 2 is a vertical cross-sectional view schematically illustrating a magnetic recording and reproducing head and a magnetic recording medium;

FIG. 3 is a schematic cross-sectional view illustrating an example of a configuration of the magnetic recording medium;

FIG. 4 is a graph illustrating the relationship between an ADC gain and a grain size of magnetic grains included in a second magnetic recording layer in Examples 1 to 3 and Comparative Example 1;

FIG. 5 is a graph illustrating the relationship between an ADC gain and a distance between a high-frequency magnetic field generating element and magnetic grains included in a second magnetic recording layer in Examples 1 and 4 to 6 and Comparative Examples 2 and 3;

FIG. 6 is a graph illustrating the relationship between an ADC gain and a distance between a high-frequency magnetic field generating element and magnetic grains included in a second magnetic recording layer or a third magnetic recording layer in Examples 1 and 4 to 6 and Comparative Examples 4-1 to 4-6; and

FIG. 7 is a graph illustrating the relationship between an ADC gain and a grain size of magnetic grains included in a second magnetic recording layer or a third magnetic recording layer in Examples 1 to 3 and Comparative Examples 5-1 to 5-4.

### DETAILED DESCRIPTION

There is a continuous demand for a high recording density in a magnetic recording and reproducing apparatus.

According to one aspect of the present disclosure, it is possible to provide a magnetic recording and reproducing apparatus which enables a high recording density with an enhanced assist effect induced by a microwave magnetic field.

Hereinafter, embodiments of the present disclosure will be described in detail. In order to facilitate understanding of the description, the same reference numerals are given to the same components in each of the drawings, and duplicate descriptions are omitted. In addition, the scale of each member in the drawings may differ from the actual scale. In the present specification, a numerical range includes both the lower and upper limit values unless otherwise specified. When the upper limit of a numerical range is expressed in particular units, the lower limit is understood to be expressed in the same units.

A magnetic recording and reproducing apparatus according to an embodiment of the present disclosure (or simply “the present embodiment”) includes a magnetic recording medium and a magnetic recording and reproducing head including a high-frequency magnetic field generating element. The magnetic recording and reproducing head includes a recording magnetic pole for generating a recording magnetic field for writing information onto the magnetic recording medium. The width of the recording magnetic pole is within a range from 30 nm to 80 nm in a radial direction of the magnetic recording medium, and the width of the high-frequency magnetic field generating element is narrower than the width of the recording magnetic pole. A magnetic recording layer closest to the high-frequency magnetic field generating element is a granular layer containing isolated Co—Pt grains having an hcp structure with c-axis orientation.

In the magnetic recording and reproducing apparatus according to the present embodiment, the width of the recording magnetic pole is set to fall within a range between 30 nm and 80 nm in the radial direction of the magnetic recording medium, and the width of the high-frequency magnetic field generating element is made narrower than the width of the recording magnetic pole. Furthermore, in the magnetic recording and reproducing apparatus according to the present embodiment, a magnetic layer of a granular structure containing isolated Co-Pt grains having an hcp structure with c-axis orientation is used for the magnetic recording layer closest to the high-frequency magnetic field generating element that the magnetic recording medium includes. Thus, the magnetic recording and reproducing apparatus according to the present embodiment can obtain a further enhanced assist effect induced by the microwave magnetic field and an increased recording density.

In order to increase the recording density of a magnetic recording medium incorporated in a magnetic recording and reproducing apparatus, it is generally necessary to reduce the width of a recording magnetic pole of a magnetic head used for writing information onto the magnetic recording medium. However, reducing the width of the recording magnetic pole causes a decrease in the intensity of a recording magnetic field and an increase in non-uniformity of a magnetic field distribution on the recording surface. As a result, the intensity of a magnetic signal written onto a magnetic recording layer may be reduced and become unstable, thereby increasing the likelihood of read errors during reproduction of the recorded information.

To address these issues, the magnetic head is configured so that a width of a high-frequency magnetic field generating element is narrower than a width of a recording magnetic pole of the magnetic head while a sufficient width of the recording magnetic pole for writing information is ensured. Thus, magnetization reversal occurs only in a region where the assist magnetic field produced by the high-frequency magnetic field generating element is superimposed, under the condition that magnetization reversal of the magnetic recording layer does not occur solely due to the recording magnetic field. At this time, in the case of a conventional magnetic recording medium having a CAP layer, there has been a problem that the intensity of a microwave magnetic field generated by a high-frequency magnetic field generating element is reduced. In particular, attenuation in the film-thickness direction of the magnetic recording layer becomes significant, resulting in a reduced assist effect of the microwave magnetic field and inhibition of the magnetization reversal in the magnetic recording layer.

In order to enhance the assist effect induced by the high-frequency magnetic field, the inventor of the present invention adopted a granular structure for the magnetic grains included in the magnetic recording layer closest to the high-frequency magnetic field generating element. This is because the magnetic grains having a granular structure can reduce the exchange interaction between the grains, thereby reducing the magnetization reversal scale in the assist region and facilitating a smaller and more uniform magnetization transition region. In other words, the assist effect on the magnetization reversal of the magnetic grains by the microwave magnetic field occurs when the precession of the magnetic grains is induced by ferromagnetic resonance. This is because the magnetic grains having a granular structure can reduce the exchange interaction between the grains, thereby facilitating the occurrence of precession in magnetic grains having a small magnetization transition region.

Furthermore, the magnetic recording layer of the granular structure includes magnetic grains surrounded by an oxide, a nitride, a boride, a carbide, or the like. These materials surrounding the magnetic grains have a higher dielectric constant and a higher permeability to high-frequency magnetic fields than the magnetic grains themselves. It has therefore become possible to suppress attenuation of the high-frequency magnetic field in the thickness direction of the magnetic recording layer. For this reason, by adopting a granular structure for the magnetic grains included in the magnetic recording layer closest to the high-frequency magnetic field generating element, it has become possible to enhance the assist effect induced by the microwave magnetic field.

### Magnetic Recording and Reproducing Apparatus

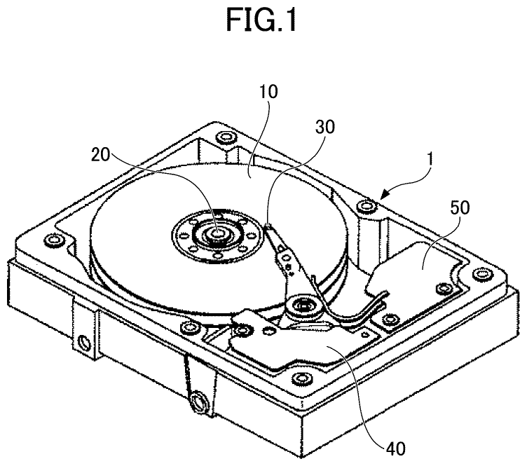

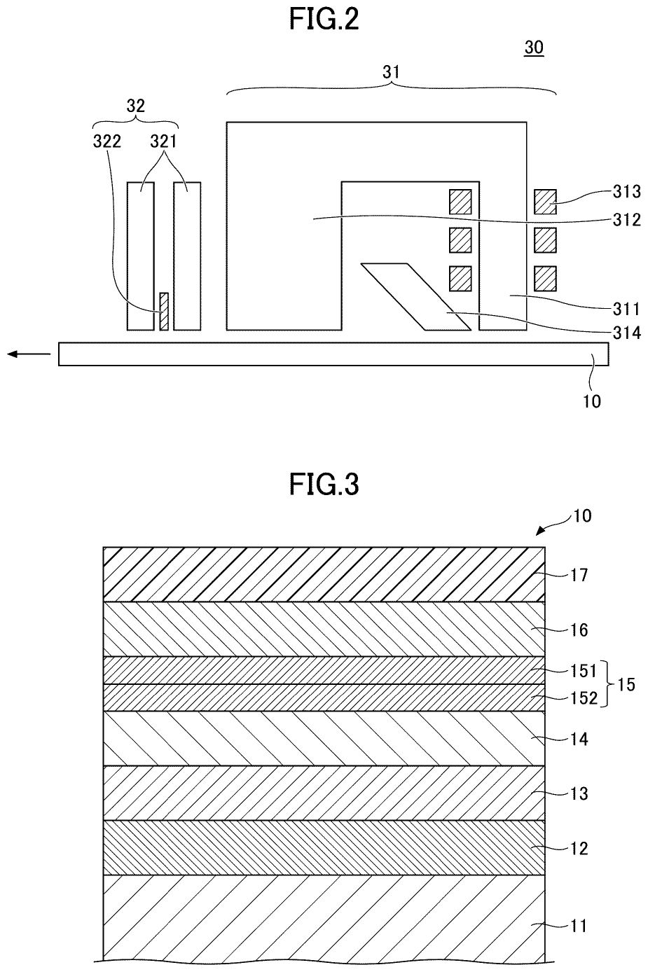

A magnetic recording and reproducing apparatus according to an embodiment of the present disclosure (hereinafter sometimes referred to simply as “the present embodiment”) will be described with reference to FIGS. 1 and 2. FIG. 1 is a perspective view schematically illustrating an example of a magnetic recording and reproducing apparatus according to the present embodiment, and FIG. 2 is a vertical sectional view schematically illustrating a magnetic recording and reproducing head and a magnetic recording medium. The arrow in FIG. 2 indicates a rotational direction (circumferential direction) of the magnetic recording medium, and a direction perpendicular to the arrow and perpendicular to the drawing sheet indicates a radial direction of the magnetic recording medium.

As illustrated in FIG. 1, the magnetic recording and reproducing apparatus 1 includes a magnetic recording medium 10 including one or more magnetic recording layers on a nonmagnetic substrate, a rotation driver 20 for rotationally driving the magnetic recording medium 10, a magnetic recording and reproducing head 30 including a high-frequency magnetic field generating element, a head driver 40 for moving the magnetic recording and reproducing head 30 in the radial direction of the magnetic recording medium 10, and a recording and reproducing signal processing system 50 for processing a signal that is input to the magnetic recording and reproducing head 30 and an output signal from the magnetic recording and reproducing head 30. The magnetic recording and reproducing apparatus 1 is a microwave-assisted magnetic recording and reproducing apparatus.

An example of the magnetic recording and reproducing head 30 is illustrated in FIG. 2. As illustrated in FIG. 2, the magnetic recording and reproducing head 30 is a microwave-assisted magnetic recording head and includes a recording head 31 and a reproducing head 32.

The recording head 31 has a recording magnetic pole 311 for generating a recording magnetic field for writing information onto a magnetic recording medium 10, an auxiliary magnetic pole 312, a coil 313 for generating a magnetic field, and a high-frequency magnetic field generating element 314.

The width of the recording magnetic pole 311 is within a range from 30 nm to 80 nm in the radial direction of the magnetic recording medium 10, and the upper limit value of the width of the recording magnetic pole 311 is preferably 60 nm, more preferably 50 nm, and most preferably 40 nm. If the width of the recording magnetic pole 311 is within the above preferred range, magnetization reversal can occur only in the assist region produced by the high-frequency magnetic field generating element 314.

The width of the high-frequency magnetic field generating element 314 is narrower than the width of the recording magnetic pole 311.

The magnetic recording layer of the magnetic recording medium 10 closest to the high-frequency magnetic field generating element 314 is a magnetic layer of a granular structure containing isolated magnetic grains including Co and Pt having an hcp structure with c-axis orientation, as described later.

The distance between the high-frequency magnetic field generating element 314 and the magnetic grains included in the magnetic recording layer is preferably 10 nm or less, more preferably 8 nm or less, and most preferably 6 nm or less. When the distance between the high-frequency magnetic field generating element 314 and the magnetic grains is 10 nm or less, the assist effect of the microwave magnetic field on the magnetic recording layer can be enhanced, so that the recording density of the magnetic recording layer can be enhanced.

The distance between the high-frequency magnetic field generating element 314 and the magnetic grains included in the magnetic recording layer is a shortest distance between the high-frequency magnetic field generating element 314 and the magnetic grains included in the magnetic recording layer. In other words, the distance between the high-frequency magnetic field generating element 314 and the magnetic grains included in the magnetic recording layer is the distance between the tip of the high-frequency magnetic field generating element 314 and a magnetic grain located closest to the tip of the high-frequency magnetic field generating element among the magnetic grains located on the outermost surface of the magnetic recording layer. The distance between the high-frequency magnetic field generating element 314 and the magnetic grains included in the magnetic recording layer may be an average value of the distances between the high-frequency magnetic field generating element and the individual magnetic grains included in the magnetic recording layer.

The distance between the high-frequency magnetic field generating element 314 and the magnetic grains included in the magnetic recording layer can be measured, for example, by using the dependence of the write frequency on a harmonic ratio of a reproduced signal.

The reproducing head 32 has shields 321 and a reproducing element 322 interposed between the shields 321.

As illustrated in FIG. 1, in the magnetic recording and reproducing apparatus 1, the central portion of the magnetic recording medium 10 is attached to the rotating shaft of a spindle motor, and information is written onto or read from the magnetic recording medium 10 while the magnetic recording and reproducing head 30 floats and travels on the surface of the magnetic recording medium 10 rotationally driven by the spindle motor.

In the magnetic recording and reproducing apparatus 1, the width of the high-frequency magnetic field generating element 314 is made narrower than the width of the recording magnetic pole 311 while a sufficient width of the recording magnetic pole 311 of the recording head 31 is ensured. Then, in the magnetic recording and reproducing apparatus 1, a magnetic layer of a granular structure having isolated magnetic grains containing Co and Pt having an hcp structure with c-axis orientation is used for the magnetic recording layer of the magnetic recording medium 10 positioned closest to the high-frequency magnetic field generating element 314 of the magnetic recording and reproducing head 30 uses. As a result, the magnetic recording and reproducing apparatus 1 can obtain a further enhanced assist effect induced by the microwave magnetic field and a high recording density, and thereby obtain an increased recording density.

### Magnetic Recording Medium

A magnetic recording medium used in the magnetic recording and reproducing apparatus according to the present embodiment will be described with reference to FIG. 3. FIG. 3 is a schematic cross-sectional view illustrating an example of the configuration of a magnetic recording medium. As illustrated in FIG. 3, the magnetic recording medium 10 includes a nonmagnetic substrate 11, a soft magnetic layer 12, a seed layer 13, an underlayer 14, a magnetic recording layer 15, a protective layer 16, and a lubricant layer 17, which are stacked in this order from the nonmagnetic substrate 11 side.

Examples of materials constituting the nonmagnetic substrate 11 include an Al alloy such as an AlMg alloy, soda glass, aluminosilicate glass, amorphous glasses, silicon, titanium, ceramics, sapphire, quartz, and resin. Among these, an Al alloy and glasses such as crystallized glass and amorphous glass are preferable.

The soft magnetic layer 12 is provided on the nonmagnetic substrate 11 and has a function of guiding a recording magnetic field from the magnetic head and efficiently applying a perpendicular component of the recording magnetic field to the magnetic recording layer 15 when recording a signal on the magnetic recording medium 10.

Examples of materials constituting the soft magnetic layer 12 include soft magnetic alloys, such as an FeCo-based alloy, a CoZrNb-based alloy, and a CoTaZr-based alloy.

The soft magnetic layer 12 preferably has an amorphous structure. This improves the surface smoothness of the soft magnetic layer 12 and reduces signal noise caused by the soft magnetic layer 12, thereby reducing the flying height of the magnetic head and further increasing the recording density of the magnetic recording medium 10.

A plurality of the soft magnetic layers 12 may be stacked with a nonmagnetic layer, such as an Ru film, interposed therebetween to form an antiferromagnetic exchange coupling (AFC) film.

The total thickness of the soft magnetic layers 12 is suitably determined by a balance between the recording and reproducing characteristics and the OW (Over Write) characteristics of the magnetic recording medium 10, and is preferably 20 nm to 120 nm.

The seed layer 13 is provided on the soft magnetic layer 12 and has a function of improving the (002) plane orientation of the underlayer 14.

As the material constituting the seed layer 13, it is preferable to use a material having an hcp structure, an fcc structure, or an amorphous structure, for example, an Ru-based alloy, an Ni-based alloy, a Co-based alloy, a Pt-based alloy, or a Cu-based alloy.

The thickness of the seed layer 13 is preferably in the range between 0.5 nm and 20 nm, and more preferably in the range between 3 nm and 10 nm. By making the thickness of the seed layer 13 within the above preferable range, the underlayer 14 can be stably (002)-oriented.

The underlayer 14 is provided on the seed layer 13, and has a function of improving the (002) plane orientation of the magnetic recording layer 15.

As the material constituting the underlayer 14, Ru having an hcp structure or an alloy thereof can be used.

The average crystal grain size of the underlayer 14 is preferably within the range between 6 nm and 20 nm, and more preferably within the range between 6 nm and 8 nm.

The thickness of the underlayer 14 can be appropriately selected, and is preferably, for example, 5 nm to 30 nm.

The magnetic recording layer 15 is provided on the underlayer 14, and information is recorded thereon. The magnetic recording layer 15 has a multilayer structure consisting of an uppermost layer 151 and one or more layers 152 other than the uppermost layer, and in the present embodiment, the magnetic recording layer closest to the high-frequency magnetic field generating element 314, that is, the uppermost layer 151 of the magnetic recording layer 15 has a granular structure containing isolated Co-Pt magnetic grains having an hcp structure with c-axis orientation.

With the uppermost layer 151 having such a structure, the assist effect induced by the high-frequency magnetic field from the high-frequency magnetic field generating element 314 can be enhanced. This is because, as described above, the magnetic grains having a granular structure can reduce the exchange interaction between the grains, which facilitates the magnetization reversal in the assist region.

In other words, the assist effect on the magnetization reversal of magnetic grains by a microwave magnetic field occurs when the precession of the magnetic grains is induced by ferromagnetic resonance. However, magnetic grains having a granular structure can reduce the exchange interaction between the grains, which facilitates the precession of the magnetic grains. A magnetic recording layer having a granular structure includes magnetic grains each surrounded by an oxide, a nitride, a boride, a carbide, or the like. These materials surrounding the magnetic grains have a higher dielectric constant and a higher permeability to high-frequency magnetic fields than the magnetic grains themselves, thereby suppressing attenuation of the high-frequency magnetic field in the film thickness direction of the magnetic recording layer.

It is preferable that the distance between the high-frequency magnetic field generating element 314 and the magnetic grains included in the uppermost layer 151 of the magnetic recording layer 15 be as close as possible. The distance between the high-frequency magnetic field generating element 314 and the magnetic grains included in the uppermost layer 151 of the magnetic recording layer 15 is preferably 10 nm or less, more preferably 8 nm or less, and most preferably 6 nm or less, for example. By making the distance between the high-frequency magnetic field generating element 314 and the magnetic grains included in the uppermost layer 151 of the magnetic recording layer 15 as close as possible, the assist effect on the uppermost layer 151 of the magnetic recording layer 15 by the microwave magnetic field can be enhanced, and the recording density of the magnetic recording layer 15 can be enhanced.

It is preferably that the grain size of the magnetic grains constituting the uppermost layer 151 of the magnetic recording layer 15 be as small as possible. The grain size of the magnetic grains is preferably 7 nm or less, and more preferably 6 nm or less. In this manner, the bit size of the magnetic recording medium 10 can be reduced, so that the recording density of the magnetic recording layer 15 can be increased.

The grain size of the magnetic grains (hereinafter also referred to as “grain diameter”) is an average grain diameter of the magnetic grains. The grain size of the magnetic grains can be measured by observing the plane of the magnetic grains with a transmission electron microscope (TEM). A freely selected number of magnetic grains (for example, 200 to 300) is observed with a TEM, and the average value of the major axis and the minor axis of the magnetic grains is defined as the grain size of the magnetic grains. In the case where the magnetic grains are spherical, a diameter of the magnetic grains is determined. In the case where the magnetic grains are elliptical, an intermediate value between the minor axis and the major axis of the magnetic grains is determined. In the case where the magnetic grains have non-uniform shapes, an intermediate value between the minor axis and the major axis of the magnetic grains is determined. Then, the obtained grain diameter distribution of the magnetic grains is prepared, and an average value of the grain diameter of the magnetic grains is determined based on the grain diameter distribution, and the average value is defined as the grain size of the magnetic grains. Hereinafter, the same measuring method can be used for the grain size of the magnetic grains included in the layer 152 other than the uppermost layer.

The material constituting the uppermost layer 151 is preferably one in which the periphery of the CoCrPt-based magnetic grains is surrounded by an oxide, a nitride, a boride, a carbide, or the like. Examples of the material constituting the uppermost layer 151 include CoCrPt—B₂O₃, CoCrPt-SiO₂, CoCrPt—Cr₂O₃, CoCrPt—TiO₂, CoCrPt—ZrO₂, CoCrPt—Nb₂O₅, CoCrPt—Ta₂O₅, and CoCrPt—TiO₂.

Examples of the material constituting the layer 152 other than the uppermost layer include CoCrPt—B₂O₃, CoCrPt—SiO₂, CoCrPt—Cr₂O₃, CoCrPt—TiO₂, CoCrPt—ZrO₂, CoCrPt—Nb₂O₅, CoCrPt—Ta₂O₅, and CoCrPt—TiO₂ when the layer 152 other than the uppermost layer has a granular structure. Examples of the material constituting the layer 152 other than the uppermost layer include CoCr, CoCrPt, and CoCrPtB when the layer 152 other than the uppermost layer has a granular structure.

As the film-forming method of the soft magnetic layer 12, the seed layer 13, the underlayer 14, and the magnetic recording layer 15, a general film-forming method, such as a DC magnetron sputtering method or an RF sputtering method, can be used.

When forming the soft magnetic layer 12, the seed layer 13, the underlayer 14 and the magnetic recording layer 15, an RF (radio frequency) bias, a DC bias, a pulsed DC bias, a pulsed DC bias, or the like may be used as necessary.

As the reactive gas, O₂ gas, H₂O gas, N₂ gas, or the like may be used.

The sputtering gas pressure is adjusted appropriately so as to optimize the characteristics of each layer, and is usually within a range of about 0.1 Pa to 30 Pa.

The protective layer 16 has a function of protecting the magnetic recording medium 10 from damage caused by contact between the magnetic head and the magnetic recording medium 10.

The protective layer 16 may contain carbon.

As a film forming method of the protective layer 16, for example, a sputtering method, a plasma CVD method, an ion beam method, or the like can be used.

The thickness of the protective layer 16 is preferably 1 nm to 5 nm, and more preferably 1 nm to 3 nm.

The lubricant layer 17 can be formed by using a liquid lubricant. A liquid lubricant having chemical stability, low friction, and low adsorption is preferably used. Examples of the liquid lubricant include a fluororesin lubricant, such as a perfluoropolyether lubricant containing a compound having a perfluoropolyether structure.

The thickness of the lubricant layer 17 is not particularly limited, but may be, for example, 0.5 nm to 2.0 nm.

Although the embodiment has been described above, the embodiment described above is presented by way of example, and the present disclosure is not limited by the embodiment described above. The embodiment described above can be practiced in various other forms, and various combinations, omissions, substitutions, or modifications can be made without departing from the gist of the invention. The embodiment described above and variations thereof are included in the scope and gist of the invention, and are included in the scope equivalent to the invention described in the claims.

### EXAMPLES

Hereinafter, the embodiment will be described in more detail by illustrating examples and comparative examples, but the embodiment are not limited by these examples and comparative examples.

### Example 1

### Preparation of Magnetic Recording Medium

A magnetic recording medium was prepared by the following method.

A cleaned glass nonmagnetic substrate (manufactured by HOYA Co., Ltd.) with an outer diameter of 3.5 inches was placed in the film formation chamber of a DC magnetron sputtering apparatus (C-3040, manufactured by Anelva), and the film formation chamber was evacuated until the attainable vacuum became 1×10⁻⁵ Pa.

Next, an adhesion layer with a thickness of 10 nm was formed on the nonmagnetic substrate using a Cr-50 at % Ti target (50 at. % Ti with the balance being Cr).

Next, a soft magnetic layer with a thickness of 25 nm was formed on the adhesion layer using a Co-30at%Fe-9at%Zr-9at%Ta target (an alloy consisting of 30 at% Fe, 9 at% Zr, and 9 at% Ta, with the balance being Co) at a temperature of 100° C. or lower.

Next, an Ni-3at%W layer with a thickness of 5 nm and an Ru layer with a thickness of 20 nm were formed on the soft magnetic underlayer in this order using a Ni-3at%W target (an alloy consisting of 3 at% W, with the balance being Ni) and a Ru target, respectively, to serve as an orientation control underlayer.

Next, a first magnetic recording layer having a granular structure with a thickness of 9 nm was formed on the orientation control underlayer using an 82mol%(Co-24at%Pt)-2mol%SiO₂-7mol%B₂O₃-9mol%TiO₂ target (an alloy consisting of an 82 mol% alloy consisting of 24 at% Pt with the balance being Co, 2 mol% SiO₂, 7 mol% B₂O₃, and 9 mol% TiO₂). At this time, the sputtering pressure was set to 2 Pa.

Next, a nonmagnetic layer having a granular structure with a thickness of 0.3 nm was formed on the first magnetic recording layer using a 91mol%(Ru-48at%Co)-9mol%TiO₂ target (an alloy consisting of a 91 mol% alloy consisting of 48 at% Co with the balance being Ru, and 9 mol% TiO₂).

Next, a second magnetic recording layer having a granular structure with a thickness of 6 nm was formed on the nonmagnetic layer using a 92mol% (Co-4at%Cr-18at%Pt)-5mol%SiO₂-3mol%TiO₂ target (an alloy consisting of a 92 mol% alloy consisting of 4 at% Cr and 18 at% Pt, with the balance being Co, 5mol% SiO₂, and 3 mol% TiO₂). At this time, the sputtering pressure was set to 2 Pa. The grain size of the magnetic grains included in the obtained second magnetic recording layer was 7 nm.

Next, a protective layer made of hard carbon was formed on the second magnetic recording layer by an ion beam method. The thickness of the protective layer is 2 nm.

Next, a lubricant layer with a thickness of 1.0 nm made of perfluoropolyether was formed on the protective layer by a dipping method. Thus, a magnetic recording medium was manufactured.

In the present embodiment, the first magnetic recording layer is the “magnetic recording layer other than the uppermost layer” and the second magnetic recording layer is the “uppermost layer of the magnetic recording layer”. The grain size of the magnetic grains included in the second magnetic recording layer and the distance between the high-frequency magnetic field generating element and the magnetic grains in this embodiment are as listed below.

### (Grain Size of the Magnetic Grains Included in the Magnetic Recording Layers)

Example 1:7 nm

### (Distance Between the High-Frequency Magnetic Field Generating Element and the Magnetic Grains Included in the Second Magnetic Recording Layer)

Example 1:10 nm

### Evaluation

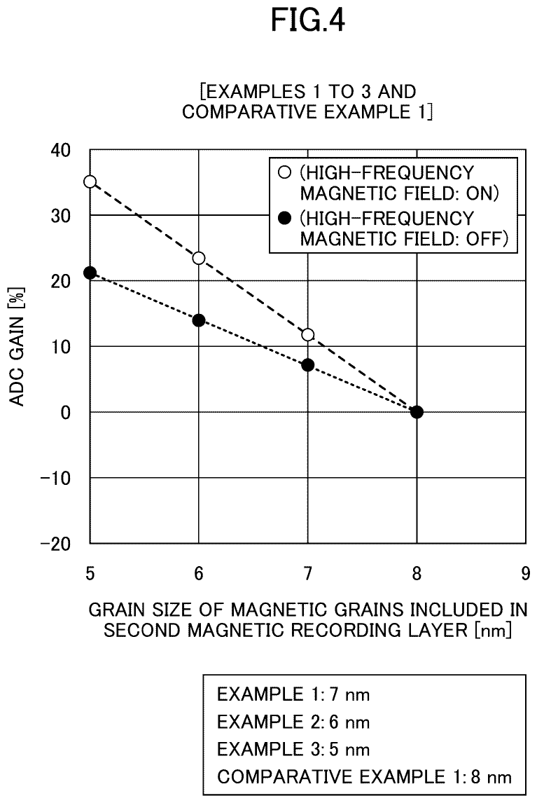

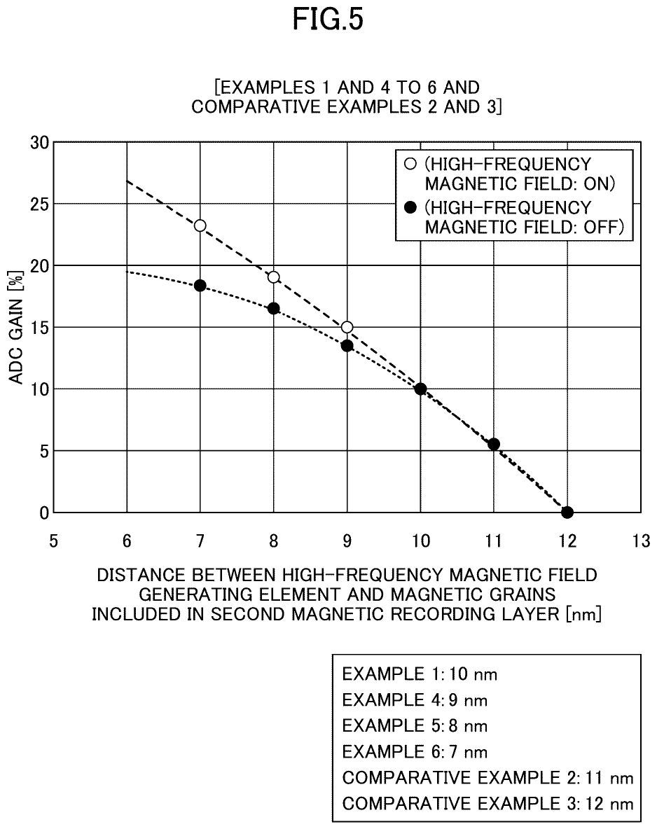

The areal density capability (ADC) was measured for the manufactured magnetic recording medium. The ADC was measured by a spin stand tester using an MAMR head. The width of the recording magnetic pole of the MAMR head was 40 nm in the radial direction of the magnetic recording medium, and the width of the high-frequency magnetic field generating element was 35 nm in the radial direction of the magnetic recording medium. The measurement was performed on the assumption that the distance between the high-frequency magnetic field generating element and the magnetic grains included in the second magnetic recording layer was 10 nm. The ADC was calculated by the product of a maximum track density (TPI) (tracks per inch) and a maximum bit density (BPI) (bits per inch) of the manufactured magnetic recording medium. The larger the value of the ADC, the higher the recording density. The ADC was measured both when the high-frequency magnetic field generating element was turned on (microwave-assisted magnetic recording method) and when it was turned off (conventional recording method). The ADC measurement results are illustrated in FIGS. 4 and 5.

FIG. 4 illustrates the relationship between an ADC gain and the grain size of the magnetic grains included in the second magnetic recording layer. In FIG. 4, using the ADC gain in the case where the grain size of the magnetic grains is 8 nm (Comparative Example 1), which will be described later, as a reference value, the ADC gain on the vertical axis is expressed by a value obtained by multiplying the ratio of the ADC gain of Example 1 to the reference value (the ADC gain of Comparative Example 1) by 100, as represented by Expression (I) below, and indicates the amount of improvement (difference) in the ADC gain.

$$ADC gain [ \% ] = ( ADC gain of Example 1 ) / ( ADC gain of Comparative Example 1 ) \times 100 \qquad Expression ( I )$$

FIG. 5 illustrates the relationship between the ADC gain and the distance between the high-frequency magnetic field generating element and the magnetic grains included in the second magnetic recording layer. In FIG. 5, using the ADC gain in the case where the distance between the high-frequency magnetic field generating element and the magnetic grains is 12 nm (Comparative Example 3), which will be described later, as a reference value, the ADC gain on the vertical axis is expressed by a value obtained by multiplying the ratio of the ADC gain of Example 1 to the reference value (the ADC gain of Comparative Example 3) by 100, as represented by Expression (II) below, and indicates the amount of improvement (difference) in the ADC gain.

$$ADC gain [ \% ] = ( ADC gain of Example 1 ) / ( ADC gain of Comparative Example 3 ) \times 100 \qquad Expression ( II )$$

### Examples 2 and 3 and Comparative Example 1

In Example 1, the measurement was carried out in the same manner as in Example 1, except that the grain size of the Ru layer was changed by changing the thickness of the Ni-3at%W layer, and the grain size of the magnetic grains included in the second magnetic recording layer was changed within a range between 5 nm and 8 nm as listed below. FIG. 4 illustrates the ADC measurement results of Examples 2 and 3 and Comparative Example 1.

### (Grain Size of the Magnetic Grains Included in the Second Magnetic Recording Layer)

Example 2:6 nm
Example 3:5 nm
Comparative Example 1:8 Nm

As illustrated in FIG. 4, the ADC gains of Examples 1 to 3 were higher than that of Comparative Example 1. Therefore, it was confirmed that the smaller the magnetic grains included in the second magnetic recording layer, the higher the ADC gain, and the more remarkably the ADC gain was improved when the high-frequency magnetic field generating element was turned on (microwave-assisted magnetic recording method) than when it was turned off (conventional recording method).

### Examples 4 to 6 and Comparative Examples 2 and 3

In Example 1, the measurement was carried out in the same manner as in Example 1 except that the distance between the high-frequency magnetic field generating element and the magnetic grains included in the second magnetic recording layer was changed in the range of 6 nm to 12 nm as listed below. FIG. 5 illustrates the ADC measurement results of Examples 4 to 6 and Comparative Examples 2 and 3.

### (Distance Between the High-Frequency Magnetic Field Generating Element and the Magnetic Grains Included in the Second Magnetic Recording Layer)

Example 4:9 nm
Example 5:8 nm
Example 6:7 nm
Comparative Example 2:11 nm
Comparative Example 3:12 nm

### Evaluation

As illustrated in FIG. 5, the ADC gains of Examples 1 and 4 to 6 were higher than the ADC gains of Comparative Examples 2 and 3. Therefore, it was confirmed that the shorter the distance between the high-frequency magnetic field generating element and the magnetic grains included in the second magnetic recording layer, the higher the ADC gain becomes, and that the ADC gain is remarkably improved when the high-frequency magnetic field generating element is turned on (microwave-assisted magnetic recording method) compared to when it is turned off (conventional recording method).

### Comparative Examples 4-1 to 4-6

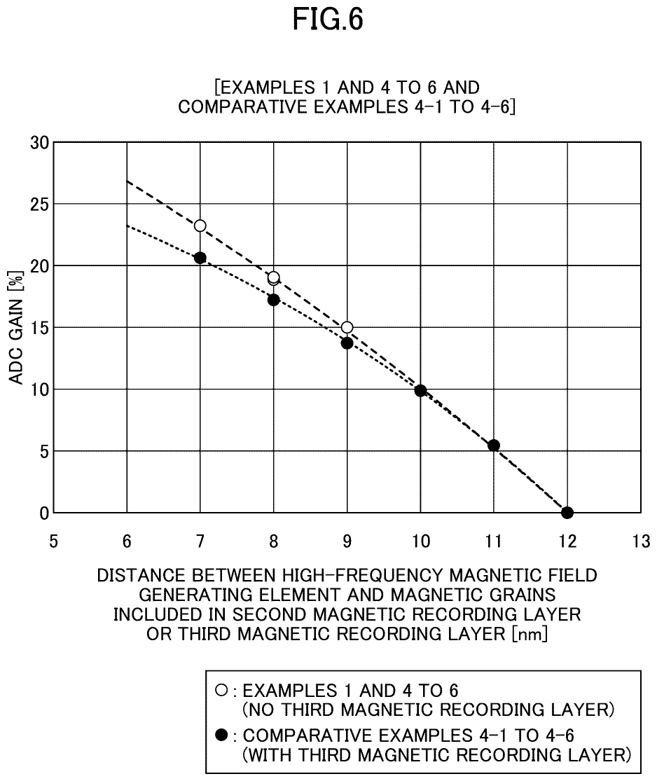

In Example 1, a film of 52at%Co-18at%Cr-20at%Pt-10at%B having a thickness of 1.3 nm was provided as a third magnetic recording layer between the second magnetic recording layer and the protective layer. The third magnetic recording layer was a magnetic recording layer having a non-granular structure. The grain size of the magnetic grains included in the third magnetic recording layer was 7.3 nm. The ADC measurement was carried out by changing the distance between the high-frequency magnetic field generating element and the magnetic grains included in the third magnetic recording layer every 1 nm in the range of 7 nm to 12 nm as listed below. Other than that, the measurement was performed in the same manner as in Example 1. FIG. 6 illustrates the ADC measurement results of Comparative Examples 4-1 to 4-6.

### (Distance Between the High-Frequency Magnetic Field Generating Element and the Magnetic Grains Included in the Third Magnetic Recording Layer)

Example 4-1: 7 nm
Example 4-2: 8 nm
Example 4-3: 9 nm
Comparative Example 4-4: 10 nm
Comparative Example 4-5: 11 nm
Comparative Example 4-6: 12 nm

In FIG. 6, using the ADC gain in the case where the distance between the high-frequency magnetic field generating element and the magnetic grains included in the third magnetic recording layer is 12 nm (Comparative Example 4-6) as a reference value, the ADC gain on the vertical axis is expressed by a value obtained by multiplying the ratio of the ADC gain of any one of Comparative Examples 4-1 to 4-5 to the reference value (the ADC gain of Comparative Example 4-6) by 100, as represented by Expression (III) below. In other words, the ADC gain on the vertical axis indicates the amount of improvement (difference) of the ADC gains of Comparative Examples 4-1 to 4-5 with respect to the ADC gain of Comparative Example 4-6. FIG. 6 also illustrates the results of the magnetic recording medium without the third magnetic recording layer, that is, the results in Examples 1 and 4 to 6 and Comparative Examples 2 and 3.

$$ADC gain [ \% ] = ( ADC gain of any one of Comparative Examples 4 - 1 to 4 - 5 ) / ( ADC gain of Comparative Example 4 - 6 ) \times 100 \qquad Expression ( III )$$

As illustrated in FIG. 6, the ADC gains of Examples 1 and 4 to 6 were higher than the ADC gains of Comparative Examples 4-1 to 4-3. Therefore, it was confirmed that the ADC gain was improved as the magnetic recording layer closest to the high-frequency magnetic field generating element was made to have a granular structure and the distance between the high-frequency magnetic field generating element and the magnetic recording layer was shortened.

### Comparative Examples 5-1 to 5-4

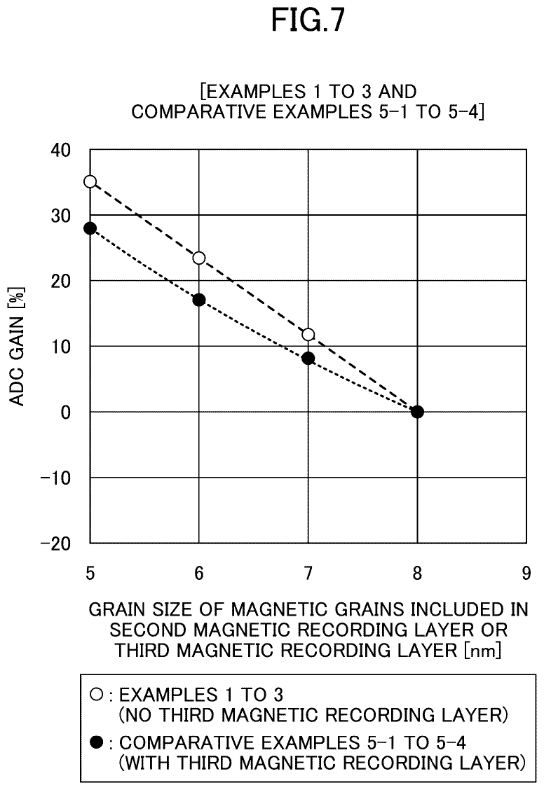

In Example 1, a film of 52at%Co-18at%Cr-20at%Pt-10at%B having a thickness of 1.3 nm was provided as a third magnetic recording layer between the second magnetic recording layer and the protective layer. The third magnetic recording layer is a magnetic recording layer having a non-granular structure. By changing the film thickness of the Ni-3at%W layer, the grain size of the Ru layer was changed, and the grain size of the magnetic grains included in the second magnetic recording layer was changed every 1 nm within a range of 5 nm to 8 nm as listed below. Otherwise, the same procedure as in Example 1 was performed. FIG. 7 illustrates the ADC measurement results of Comparative Examples 5-1 to 5-4.

### (Grain Size of the Magnetic Grains Included in the Third Magnetic Recording Layer)

Example 5-1: 5 nm
Example 5-2: 6 nm
Comparative Example 5-3: 7 nm
Comparative Example 5-4: 8 nm

In FIG. 7, using the ADC gain in the case where the grain size of the magnetic grains included in the third magnetic recording layer is 8 nm (Comparative Example 5-4) as a reference value, the ADC gain on the vertical axis is expressed by a value obtained by multiplying the ratio of the ADC gain of any one of Comparative Examples 5-1 to 5-3 to the reference value (the ADC gain of Comparative Example 5-4) by 100, as represented by Expression (IV) below. In other words, the ADC gain on the vertical axis indicates the amount of improvement (difference) of the ADC gains of Comparative Examples 5-1 to 5-3 with respect to the ADC gain of Comparative Example 5-4. FIG. 7 also illustrates the results of a magnetic recording medium without the third magnetic recording layer, that is, the results in Examples 1 to 3 and Comparative Examples 2 and 3.

$$ADC gain [ \% ] = ( ADC gain of any one of Comparative Examples 5 - 1 to 5 - 3 ) / ( ADC gain of Comparative Example 5 - 4 ) \times 100 \qquad Expression ( IV )$$

As illustrated in FIG. 7, the ADC gains of Examples 1 to 3 were higher than the ADC gains of Comparative Examples 5-1 to 5-3. Therefore, it was confirmed that the ADC gain was improved as the magnetic recording layer closest to the high-frequency magnetic field generating element was made to have a granular structure and the grain size of the magnetic grains included in the magnetic recording layer was reduced.

What is claimed is:

1. A magnetic recording and reproducing apparatus, comprising:
a magnetic recording medium including a plurality of magnetic recording layers disposed on a nonmagnetic substrate; and
a magnetic recording and reproducing head including a high-frequency magnetic field generating element, wherein the magnetic recording and reproducing head includes a recording pole configured to generate a recording magnetic field for writing information onto the magnetic recording medium,
the recording pole has a width within a range between 30 nm and 80 nm in a radial direction of the magnetic recording medium,
the high-frequency magnetic field generating element has a width smaller than that of the recording pole, and
one of the plurality of magnetic recording layers that is closest to the high-frequency magnetic field generating element is a magnetic layer having a granular structure containing isolated magnetic grains including Co and Pt and having an hcp structure with c-axis orientation.

2. The magnetic recording and reproducing apparatus according to claim 1, wherein
a distance between the high-frequency magnetic field generating element and the magnetic grains is 10 nm or less.

3. The magnetic recording and reproducing apparatus according to claim 1, wherein
a grain size of the magnetic grains is 7 nm or less.

4. The magnetic recording and reproducing apparatus according to claim 1, wherein
the plurality of magnetic recording layers are stacked on the nonmagnetic substrate.

5. The magnetic recording and reproducing apparatus according to claim 1, further comprising:
a rotation driver configured to rotationally drive the magnetic recording medium;
a head driver configured to move the magnetic recording and reproducing head in the radial direction of the magnetic recording medium; and
a recording and reproducing signal processing system configured to process a signal that is input to the magnetic recording and reproducing head and an output signal from the magnetic recording and reproducing head.
